(19) United States
(12) Patent Application Publication
(10) Pub. No.: US 2018/0321767 A1
(43) Pub. Date: Nov. 8, 2018

(54) SPRING-BASED CAPACITIVE TOUCH-SENSING STRUCTURE AND CAPACITIVE TOUCH-SENSING CONTROL PANEL FOR GEL NAIL PHOTOCURING MACHINE

(71) Applicant: COSMEX CO., LTD., New Taipei City (TW)

(72) Inventors: Wan Chieh Hsieh, New Taipei City (TW); Hao-Hong Ciou, New Taipei City (TW); Lin-Yu Sia, New Taipei City (TW); Chun Ching Liu, New Taipei City (TW)

(21) Appl. No.: 15/969,105

(22) Filed: May 2, 2018

(30) Foreign Application Priority Data
May 3, 2017 (TW) 106206199

(51) Int. Cl. G06F 3/044

(52) U.S. Cl. CPC G06F 3/044; G06F 2203/04103

(57) ABSTRACT

The present invention is to provide a spring-based capacitive touch-sensing structure, comprising: a substrate and a touch panel provided on one side of the substrate. The substrate provided thereon with an electrode unit and one or a plurality of conductive springs electrically connected to the electrode unit. The touch panel has a bottom side in contact with the one or the plurality of conductive springs such that a surface of an opposite side of the touch panel is coupled with the one or the plurality of conductive spring to enable touch-based input. Thanks to the compressibility of the conductive springs in the present invention, tolerances for dimensional errors are ensured once the conductive springs are installed. In other words, the resulting product will not have dimensional errors even if the unmolding or manufacturing process is carried out with limited precision.

### BACKGROUND OF THE INVENTION

### 1. Technical Field

The present invention relates to a touch-sensing structure and a capacitive touch-sensing control panel and more particularly to a spring-based capacitive touch-sensing structure and capacitive touch-sensing control panel for gel nail photocuring machine.

### 2. Description of Related Art

Photocurable artificial fingernails are imitation fingernails formed by curing a photocurable gel with ultraviolet (UV) light. More specifically, a non-toxic natural photocurable resin is applied to a natural fingernail and then cured by irradiation such that a protective layer is formed on the surface of the natural nail. Apart from protecting the nail surface, the protective layer adds to the thickness and rigidity of the natural nail and helps correct the nail shape. The transparent or translucent resin also lends lucidity and charm to the natural nail.

The irradiation devices used in the aforesaid curing process are generally known as gel nail photocuring machines or nail beautifying machines. A typical gel nail photocuring machine includes a control panel for turning on and off the machine and controlling the irradiation time of UV light-emitting diodes (LEDs). Conventionally, such a machine is operated through physical press-buttons, which serve as a man-machine interface for triggering and controlling the control panel; however, equipping a gel nail photocuring machine with the traditional physical press-buttons causes inconveniences in many ways. For example, due to structural limitations, physical press-buttons cannot be arranged on a gel nail photocuring machine as flexibly as desired, which restricts the possibilities of exterior design of the machine. In addition, a manicurist or user must apply a certain amount of force in order to press the press-buttons, which can be an undesirable operation experience. Moreover, physical press-buttons tend to be stuck or suffer from poor electrical contact after long-term or repeated use, which in turn shortens the service life of a gel nail photocuring machine. In light of the aforementioned drawbacks, the inventor of the present invention thought it necessary to improve the conventional gel nail photocuring machines.

### BRIEF SUMMARY OF THE INVENTION

One objective of the present invention is to solve the foregoing problems of the prior art, namely the required exertion of force to press the traditional press-buttons on the conventional gel photocuring machines and the great possibility of the press-buttons getting stuck after long-term use.

To achieve the foresaid objective, the present invention provides a spring-based capacitive touch-sensing structure, comprising: a substrate and a touch panel provided on one side of the substrate. The substrate provided thereon with an electrode unit and one or a plurality of conductive springs electrically connected to the electrode unit. The touch panel has a bottom side in contact with the one or the plurality of conductive springs such that a surface of an opposite side of the touch panel is coupled with the one or the plurality of conductive spring to enable touch-based input.

Further, the touch panel is an insulating panel.

Further, a plurality of light-emitting units are provided inside the conductive springs respectively to emit light toward the touch panel.

Further, the touch panel is made of a transparent or translucent material.

Another objective of the present invention is to provide a capacitive touch-sensing control panel for a gel nail photocuring machine, wherein the capacitive touch-sensing control panel is provided on the gel nail photocuring machine to turn on and off, and control a working mode of, the gel nail photocuring machine, the capacitive touch-sensing control panel comprising: a substrate, a touch panel provided on one side of the substrate, and a controller provided on the substrate. The substrate provided thereon with one or a plurality of electrode units and one or a plurality of conductive springs electrically connected to the one or the plurality of electrode units. The touch panel has a bottom side in contact with the one or the plurality of conductive springs such that a surface of the touch panel is coupled with the one or the plurality of conductive springs. The controller electrically connected to the one or the plurality of electrode units, wherein the controller is configured to detect variation of electric potential of the one or the plurality of conductive springs, and the variation of the electric potential triggers a control signal.

Further, the touch panel is an insulating panel.

Further, a plurality of light-emitting units are provided inside the conductive springs respectively to emit light toward the touch panel.

Further, the touch panel is made of a transparent or translucent material.

Further, the substrate is provided thereon with one or a plurality of displays connected to the controller.

Further, the substrate is provided thereon with a plurality of light-emitting units that are arranged around the display and the conductive springs.

Therefore, the present invention has the following beneficial effects compared with the prior art:

1. The present invention replaces the traditional physical press-buttons of a gel nail photocuring machine with a spring-based capacitive touch-sensing structure. A user, therefore, is spared the exertion of force otherwise required to press physical press-buttons and has to worry no more about stuck press-buttons, which is a common issue with the traditional physical press-buttons after long-term or repeated use.

2. Thanks to the compressibility of the conductive springs in the present invention, tolerances for dimensional errors are ensured once the conductive springs are installed. In other words, the resulting product will not have dimensional errors even if the unmolding or manufacturing process is carried out with limited precision.

### BRIEF DESCRIPTION OF THE DRAWINGS

FIG. 1 shows partial sectional view of spring-based capacitive touch-sensing structure according to the present invention.

FIG. 2 shows a configuration schematic view of a capacitive touch-sensing control panel and a gel nail photocurirg machine according to the present invention.

FIG. 3 shows an exploded perspective schematic view of a capacitive touch-sensing control panel of the present invention.

FIG. 4 shows a front schematic view of a capacitive touch-sensing control panel according to the present invention.

FIG. 5 shows a rear schematic view of a capacitive touch-sensing control panel according to the present invention.

FIG. 6 shows a lateral schematic view of a capacitive touch-sensing control panel according to the present invention.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

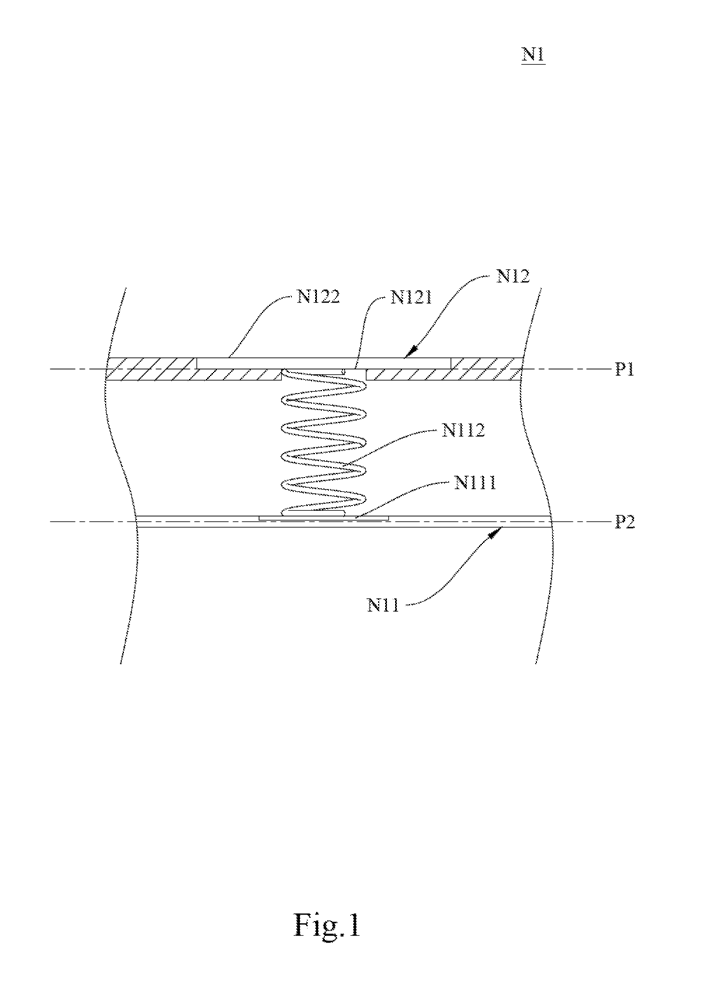

Please refer to FIG. 1 for a partial sectional view of a spring-based capacitive touch-sensing structure according to the present invention.

As shown in FIG. 1, the spring-based capacitive touch-sensing structure N1 includes a substrate N11 and a touch panel N12 arranged above the substrate N11. The substrate N11 is provided thereon with an electrode unit N111 and one or a plurality of conductive springs N112 electrically connected to the electrode unit N111. The touch panel N12 is provided on one side of the substrate N11. The bottom side N121 of the touch panel N12 is in contact with the one or the plurality of conductive springs N112 such that the surface N122 of the opposite side of the touch panel N12 is coupled with the one or the plurality of conductive springs N112 to enable touch-based input. According to the foregoing arrangement, the one or the plurality of conductive springs N112 provide tolerances for dimensional errors between a first position P1, where the touch panel N12 is positioned, and a second position P2, where the substrate N11 is positioned.

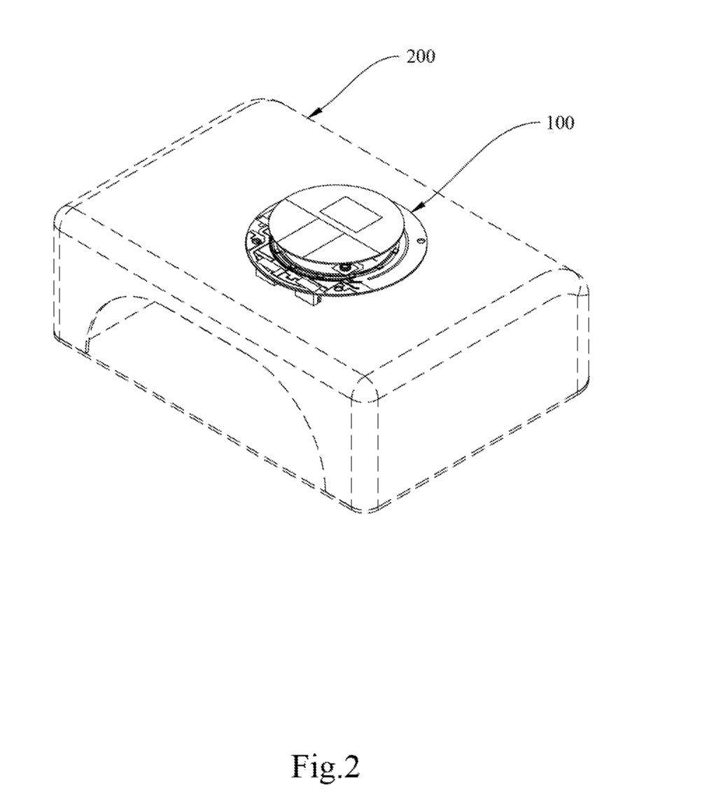

An application of the present invention is described below with reference to FIG. 2, which shows how a capacitive touch-sensing control panel according to the invention is arranged in relation to a gel nail photocuring machine.

As shown in FIG. 2, the disclosed capacitive touch-sensing control panel 100 is provided on a gel nail photocuring machine 200 and is connected to the power supply, the UV LED lamps, and the input and output devices (not shown) of the gel nail photocuring machine 200 in order to turn on and off, and control the working mode of, the gel nail photocuring machine 200.

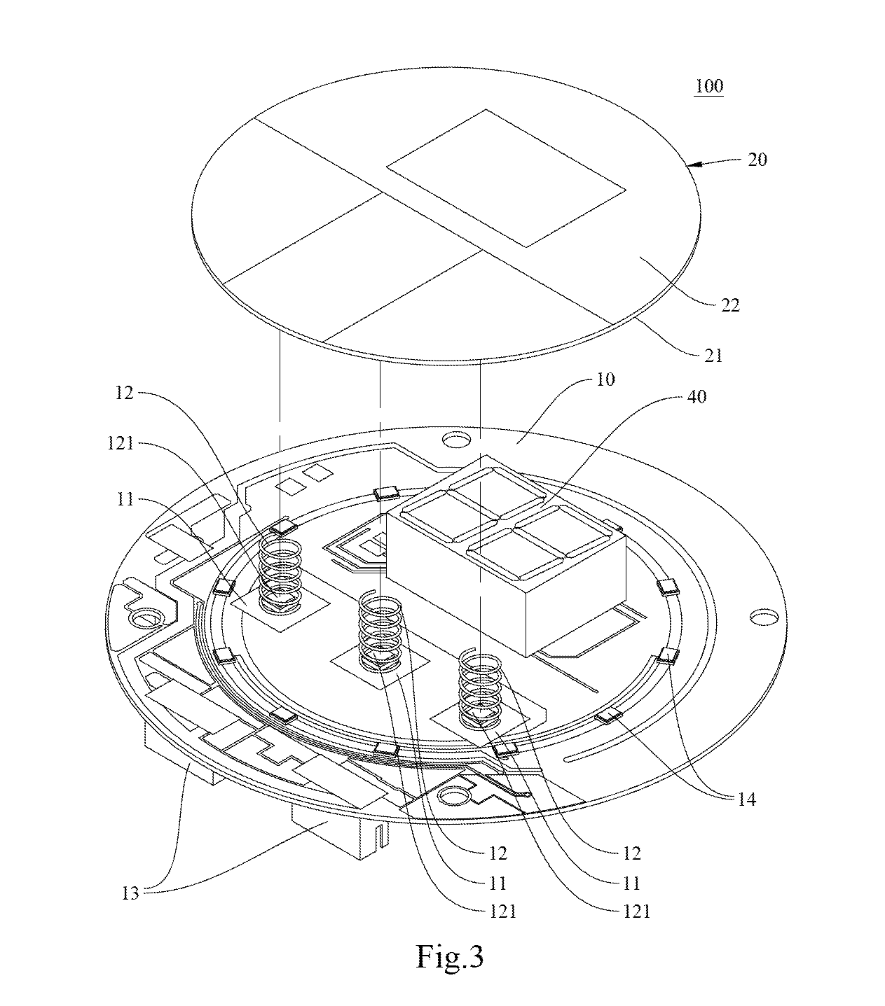

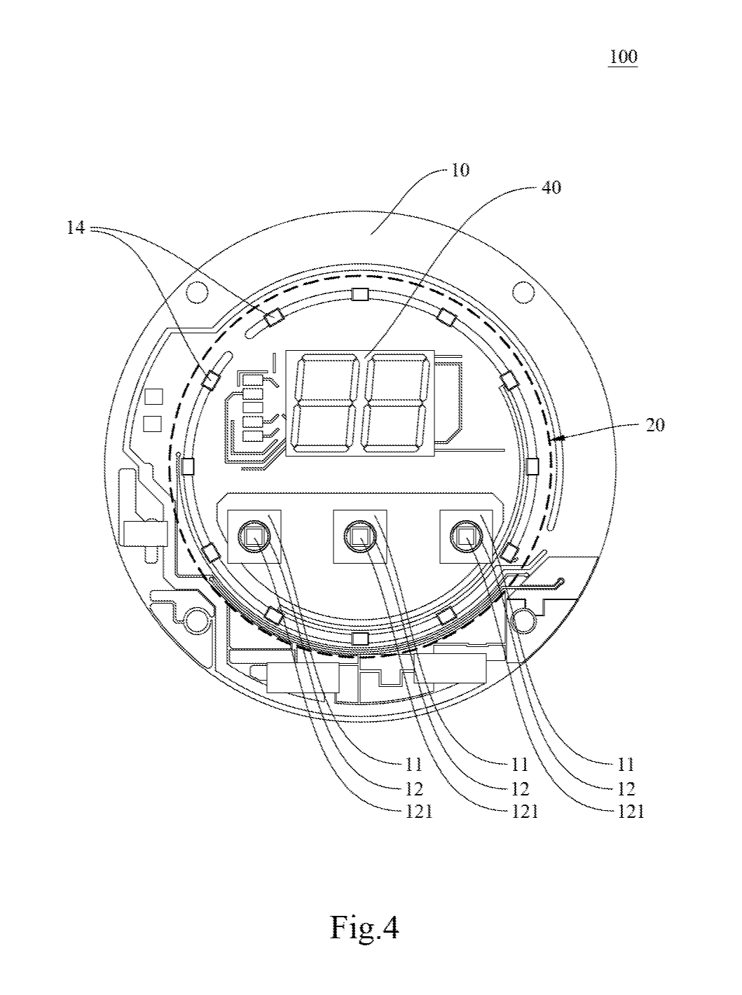

The structural details and functions of the capacitive touch-sensing control panel 100 are explained below with reference to FIG. 3 and FIG. 4, which show an exploded perspective view and a front view of the capacitive touch-sensing control panel respectively.

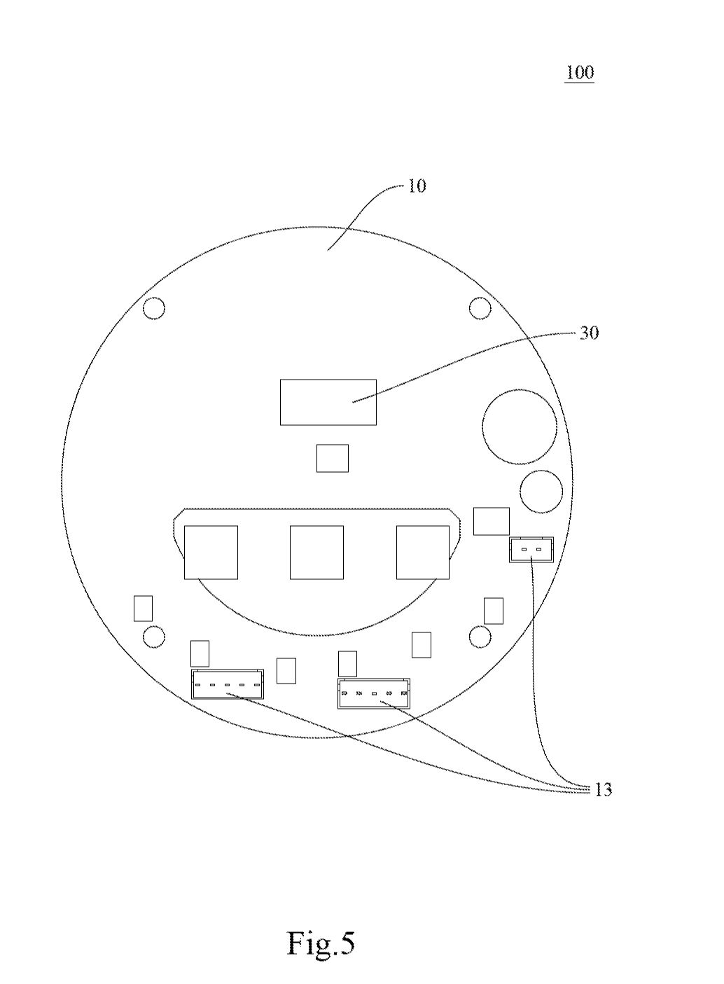

The capacitive touch-sensing control panel 100 essentially includes a substrate 10, a touch panel 20 provided on one side of the substrate 10, and a controller 30 (see FIG. 5) provided on the substrate 10.

The substrate 10 is provided thereon with one or a plurality of electrode units 11 and one or a plurality of conductive springs 12. The conductive springs 12 are electrically connected to the electrode units 11 respectively so that the controller 30 can detect variation of the electric potential of the conductive springs 12 through the electrode units 11, and the variation of electric potential will trigger a corresponding control signal.

As shown in FIG. 5, the substrate 10 in this embodiment has a plurality of connection ports 13 on the backside. The connection ports 13 are configured to connect respectively with the power socket (or power supply, as in other preferred embodiments), the light obstruction detectors, the UV LED connection ports (not shown), the fan, and other visually pleasing or functional lighting devices of the gel nail photocuring machine 200. The present invention has no limitation on the devices to which the connection ports 13 are respectively connected.

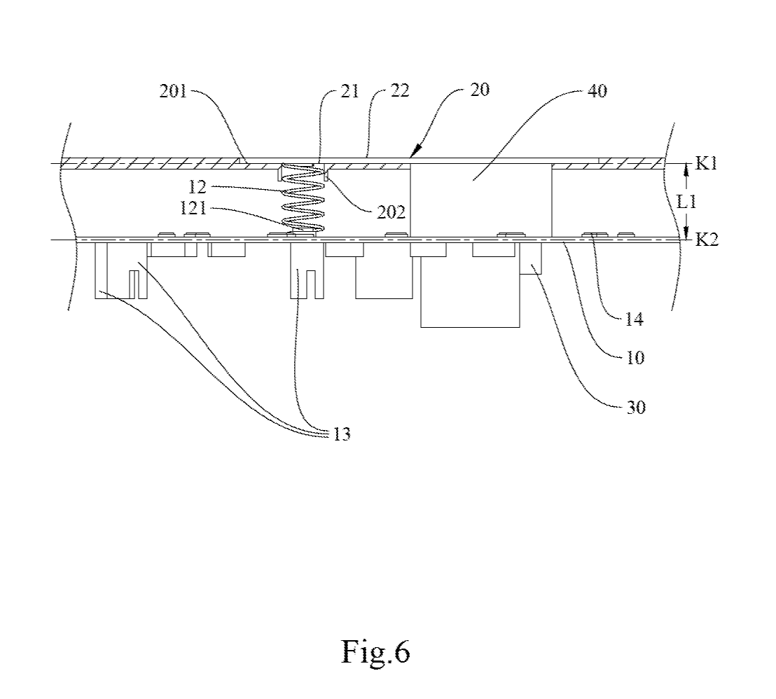

Please refer also to FIG. 6, which shows a side view of the capacitive touch-sensing control panel 100.

As shown in FIG. 6, the touch panel 20 is provided above the substrate 10, and the bottom side 21 of the touch panel 20 is in contact with the conductive springs 12 such that the surface 22 of the opposite side of the touch panel 20 is coupled with the conductive springs 12. In one preferred embodiment, the touch panel 20 is an insulating panel, but the touch panel 20 in the present invention is not limited to such panels. When a user touches the touch panel 20 with a finger, the electric potential of the conductive springs 12 is changed. The change in electric potential is detected by the controller 30 and triggers a corresponding control signal. In one preferred embodiment, the housing of the gel nail photocuring machine 200 is provided with a plurality of position-limiting mechanisms 202 corresponding in number to the conductive springs 12. The position-limiting mechanisms 202 are configured to limit the positions of the conductive springs 12 respectively and thereby keep the conductive springs 12 from separating from the bottom side 21 of the touch panel 20 and moving elsewhere. The position-limiting mechanisms 202 may be through holes, recesses, hooks, or posts; the present invention has no limitation in this regard.

In one preferred embodiment, the touch panel 20 is made of a transparent or translucent material, and a plurality of light-emitting units 121 are provided inside the conductive springs 12 respectively to emit light toward the touch panel 20, thereby lighting up the touch control area of the touch panel 20. The controller 30 can be so designed that activation of the gel nail photocuring machine 200 or of the control panel 100 triggers the controller 30 to send an activation signal to the light-emitting units 121, or that a user's touch at any position in the touch control area triggers light emission from the light-emitting unit(s) 121 corresponding to the touched position. Please note that the light-emitting units 121, which correspond in position to the touch panel 20, are not an essential technical feature of the present invention.

The controller 30 is electrically connected to the electrode units 11 and is configured to detect variation of the electric potential of the conductive springs 12, with the variation of electric potential triggering a control signal. The controller 30 may be a microprocessor, a digital signal processor (DSP), a switch controller, or any other commercial processor. The controller 30 may also be implemented by a combination of a plurality of computing devices, such as a plurality of microprocessors, a plurality of DSPs, a plurality of switch controllers, or any combination of the above; the present invention has no limitation in this regard.

In one preferred embodiment, the substrate 10 is provided thereon with one or a plurality of displays 40 connected to the controller 30. The display 40 can be used to display the working mode of the gel nail photocuring machine 200, to display time, or to measure time. More specifically, the display 40 may be a digital display, a liquid crystal display, an organic light-emitting diode (OLED) display, or the like; the present invention has no limitation in this regard. In one preferred embodiment, the touch panel 20 extends over the display 40 and appears to be constructed together with the display 40. This configuration helps enhance the entire control panel esthetically.

In one preferred embodiment, the substrate 10 is provided thereon with a plurality of light-emitting units 14 that are arranged around the display 40 and the conductive springs 12 in order to provide illumination in a circumferential configuration.

The arrangement of, and relationship between, the conductive springs 12 and the touch panel 20 are detailed below with reference to FIG. 6.

During assembly of the gel nail photocuring machine 200, the touch panel 20 is fixed at a first position K1 on the housing of the gel nail photocuring machine 200 via a positioning mechanism 201 (e.g., a groove) of the housing. Similarly, the substrate 10 is fixed at a second position K2 on the housing, or an inner housing portion, of the gel nail photocuring machine 200. The distance L1 between the substrate 10 and the touch panel 20 (i.e., between the first position K1 and the second position K2) is a fixed value in design but may deviate slightly from the fixed design value as a result of the unmolding process. As the conductive springs 12 are pressed against the bottom side 21 of the touch panel 20 when installed, the compressed lengths of the conductive springs 12 help compensate for any such deviation, ensuring that the top ends of the conductive springs 12 are in contact with the touch panel 20.

As above, the present invention replaces the traditional physical press-buttons of a gel nail photocuring machine with a spring-based capacitive touch-sensing structure. A user, therefore, is spared the exertion of force otherwise required to press physical press-buttons and has to worry no more about stuck press-buttons, which is a common issue with the traditional physical press-buttons after long-term or repeated use. Moreover, thanks to the compressibility of the conductive springs in the present invention, tolerances for dimensional errors are ensured once the conductive springs are installed. In other words, the resulting product will not have dimensional errors even if the unmolding or manufacturing process is carried out with limited precision.

While the present invention has been described in connection with certain exemplary embodiments, it is to be understood that the invention is not limited to the disclosed embodiments, but, on the contrary, intended to cover various modifications and equivalent arrangements included within the spirit and scope of the appended claims and equivalents thereof.

What is claimed is:

1. A spring-based capacitive touch-sensing structure, comprising:
a substrate provided thereon with an electrode unit and one or a plurality of conductive springs electrically connected to the electrode unit; and
a touch panel provided on one side of the substrate, wherein the touch panel has a bottom side in contact with the one or the plurality of conductive springs such that a surface of an opposite side of the touch panel is coupled with the one or the plurality of conductive spring to enable touch-based input.

2. The spring-based capacitive touch-sensing structure of claim 1, wherein the touch panel is an insulating panel.

3. The spring-based capacitive touch-sensing structure of claim 1, wherein a plurality of light-emitting units are provided inside the conductive springs respectively to emit light toward the touch panel.

4. The spring-based capacitive touch-sensing structure of claim 3, wherein the touch panel is made of a transparent or translucent material.

5. A capacitive touch-sensing control panel for a gel nail photocuring machine, wherein the capacitive touch-sensing control panel is provided on the gel nail photocuring machine to turn on and off, and control a working mode of, the gel nail photocuring machine, the capacitive touch-sensing control panel comprising:
a substrate provided thereon with one or a plurality of electrode units and one or a plurality of conductive springs electrically connected to the one or the plurality of electrode units;
a touch panel provided on one side of the substrate, wherein the touch panel has a bottom side in contact with the one or the plurality of conductive springs such that a surface of the touch panel is coupled with the one or the plurality of conductive springs; and
a controller provided on the substrate and electrically connected to the one or the plurality of electrode units, wherein the controller is configured to detect variation of electric potential of the one or the plurality of conductive springs, and the variation of the electric potential triggers a control signal.

6. The capacitive touch-sensing control panel of claim 5, wherein the touch panel is an insulating panel.

7. The capacitive touch-sensing control panel of claim 5, wherein a plurality of light-emitting units are provided inside the conductive springs respectively to emit light toward the touch panel.

8. The capacitive touch-sensing control panel of claim 7, wherein the touch panel is made of a transparent or translucent material.

9. The capacitive touch-sensing control panel of claim 5, wherein the substrate is provided thereon with one or a plurality of displays connected to the controller.

10. The capacitive touch-sensing control panel of claim 5, wherein the substrate is provided thereon with a plurality of light-emitting units that are arranged around the display and the conductive springs.
